(19) United States
(12) Patent Application Publication
(10) Pub. No.: US 2017/0367359 A1
(43) Pub. Date: Dec. 28, 2017

(54) SYSTEMS, METHODS, AND DEVICES FOR CREATING A YOGURT CULTURE

(71) Applicant: Jugurt LLC, South Jordan, UT (US)

(72) Inventor: Merrick Maxfield, South Jordan, UT (US)

(73) Assignee: Jugurt LLC, South Jordan, UT (US)

(21) Appl. No.: 15/630,753

(22) Filed: Jun. 22, 2017

Related U.S. Application Data
(60) Provisional application No. 62/493,104, filed on Jun. 23, 2016.

(51) Int. Cl. A23C 9/123; A23C 9/12

(52) U.S. Cl. CPC A23C 9/123; A23C 9/1226

(57) ABSTRACT

A yogurt fermentation system comprising a flexible insulated cover configured to cover and contact the sides of a yogurt culture container containing a yogurt culture; a heating element dispersed within the flexible insulated cover; a temperature regulator configured to regulate the heating element and maintain a temperature sufficient to ferment the yogurt culture, and methods of culturing yogurt using said system.

### CROSS-REFERENCE TO RELATED APPLICATIONS

This application claims priority to U.S. Patent Application No. 62/493,104, filed Jun. 23, 2016, titled “IN-JUG YOGURT MAKER” which is hereby incorporated by reference herein in its entirety.

### TECHNICAL FIELD

The present disclosure relates to cultured beverages and foodstuff and more particularly relates to culturing beverages and foodstuff in a home environment.

### BRIEF DESCRIPTION OF THE DRAWINGS

FIG. 1 is a front view of a yogurt culture system with a heating element on a single side, according to one embodiment.

FIG. 2 is a front view of the yogurt culture system with a heating element covering all sides of the yogurt culture container, according to one embodiment.

FIG. 3 is a sectional view of a yogurt culture system of FIG. 2, according to one embodiment.

FIG. 4 is a sectional view of a yogurt culture system having a flexible insulated cover that covers the top of the yogurt culture container, according to one embodiment.

FIG. 5 is a sectional view of a yogurt culture system having a supplemental bottom portion having a separate heating element capable of also heating the yogurt culture container from the bottom, according to one embodiment.

FIG. 6A and FIG. 6B are perspective views illustrating a yogurt culture system having a rigid heating element and a belt, according to one embodiment.

FIG. 7A and FIG. 7B are perspective views illustrating a yogurt culture system having an envelope configuration, according to one embodiment.

FIG. 8 is a perspective view illustrating a yogurt culture system having a heating insert, according to one embodiment.

FIG. 9 is a schematic flow chart diagram illustrating a method for creating yogurt or culturing a yogurt mixture, according to one embodiment.

FIGS. 10A and 10B are perspective views of a flexible cover having a edges with an hourglass profile, according to one embodiment.

FIGS. 11A, 11B, and 11C are perspective view of a yogurt culture system having an expandable and collapsible cover mounted to a base ring, according to one embodiment.

### DETAILED DESCRIPTION

Culturing yogurt can be a difficult and complicated process, typically requiring use of pots and pans, heating the milk up to 180° F., cooling until it the temperature reaches 110-115° F. (potentially exposing the culture to bad bacteria), adding a yogurt starter, and then incubating the mixture for a long period of time. In some methods, the yogurt culture may be poured into special containers with tops and placed into yogurt machines. This process can take many hours of time, requires use of special containers/thermometers/equipment, special sterilization/washing/boiling of equipment, making a mess of the kitchen, pots, pans, thermometer, cups, container, etc.

In view of such difficulties, most consumers never consider making yogurt on their own at home, and instead opt to purchase processed yogurt from the store. Unfortunately, store-bought yogurts are most often expensive, contain undesirable ingredients, preservatives, thickeners, artificial sweeteners, excessive sugar, and/or have reduced amounts of probiotics. There is currently no convenient, low-cost, or quick way to prepare yogurt at home. Moreover, most yogurt machines only make small quantities, up to a quart at a time.

Applicants have determined that there is a need for a low-cost, convenient, simple, and fast way to prepare yogurt at home as well as to be able to make yogurt in large volume batches (such as by the gallon or half gallon). Applicants developed systems and embodiments for culturing yogurt in a retail container that mounts on a retail container (e.g., to a side or top), mounts in a retail container, or may be dropped over the retail container so that users are not required to dirty other containers or utensils.

This present disclosure relates to a system and methods for culturing yogurt directly in a store-bought milk container, or other storage container, and not requiring other cooking accessories, such as pots, pans, containers, thermometers, etc. Embodiments may be used to incubate, ferment, and/or culture the milk with an added yogurt starter or culture directly in the milk jug. The systems, devices, and methods may work with a variety of standardized jugs or containers so that additional containers are not needed. The user doesn't need to dirty any kitchen equipment, such as dishes, pots, thermometer, etc. Nor is there any need to preheat, cool, transfer, containerize, measure temperature of the milk or yogurt mixture.

Furthermore, at least some embodiments are compact and can be folded, rolled, or collapsed to be stored within a confined location, such as a drawer. More compact storage may be possible in at least some embodiments due to flexibility, size, and/or because a heating element and/or cover may depend on the structure or rigidity of a container for support.

Reference will now be made to the drawings in which the various elements of the illustrated configurations will be given numerical designations and in which embodiments will be discussed so as to enable one skilled in the art to make and use the systems, methods, and devices disclosed herein. It is to be understood that the following description is only by of examples of the principles of the present disclosure, and should not be viewed as narrowing the claims which follow.

The present disclosure relates to devices, systems and methods for making yogurt in the same milk container in which the milk was purchased. There is a need for a simple, quick, low-cost way to make yogurt/probiotics directly in the milk container. Existing products require the user to get out and sterilize numerous utensils, pots, pans, containers, and/or thermometers. Then the milk is poured into a different container to be preheated up to about 180° F./85° C. The user must often waste countless amounts of time carefully monitoring the temperature to not ruin the entire batch. Next the user may be required to carefully let the mixture cool to the precise desired temperature (many will fill up their sink with ice water to speed up this process).

Following cooling, the user may finally add the probiotic starter culture. The solution may be mixed again and then put into a plurality of containers for incubation (some recommend preheating the bottles/containers as well). Finally, the mixture can be placed into a yogurt machine to incubate/ferment. The amount of wasted time may continue as the user must clean/sterilize pots, pans, containers, thermometer, utensils, or other equipment. The user must also put all the equipment away for the next batch (usually only small batch sizes are available with existing yogurt machines).

Applicants have developed an improved way to prepare a yogurt culture which may require less than a minute of preparation time by a user. For example, the user may start with a fresh gallon of milk from the store, add culture, shake the container, place the container into a yogurt culture system (or place/mount the yogurt culture system on the container), such as a system disclosed herein, and then walk away. The user can come back the next morning or after school or work and the yogurt culture process is finished. The container with the cultured product may be placed into a refrigerator to cool. Flavoring may be added or the cultured product may be mixed into other consumables, such as a shake or smoothie. Thus, the same container in which the milk or other product was purchased may be used for culturing, flavoring, storage, and/or dispensing of a yogurt product.

Although many embodiments are disclosed as creating a yogurt culture, the disclosure contemplates creation or culturing of solid, semi-solid, or liquid foodstuffs which are known by a variety of names. For example, cultured foods may include fermented animal or plant milk, plants, or other liquid or solid foodstuff. Cultured foodstuff may include yogurt, kefir, water kefir, or other cultured edible products, for example.

The components utilized in the present disclosure may include an apparatus made to accept, mate to, lower over, encase, contain or insert into existing standard milk jugs, a method of heating the milk to the appropriate temperature, and a temperature control method to make sure the milk temperature does not exceed the desire maximum temperature and kill the yogurt starter cultures/probiotics. Embodiments may include any type of structure, strap, cover, or mechanism to attach or hold a heating element to a container. The structure, strap, cover, or mechanism may be sized or configured to adapt to a plurality of different sizes or types of containers, such as standard container sizes and types in which milk is often sold within a region. Example standardized containers include gallon, half gallon, quart, or other sized containers. Some standardized containers may include the same opening and threading sizes for container openings. Thus, some embodiments may use threaded mechanisms for attaching or supporting a heating element relative to the container.

In at least one embodiment, a yogurt culture system includes a flexible insulated cover configured to cover and contact the sides of a yogurt culture container containing a yogurt culture; a heating element dispersed within the flexible insulated cover, and a temperature regulator configured to regulate the heating element and maintain a temperature sufficient to culture and ferment the yogurt culture.

The flexible insulated cover may include any suitable material or mix of materials suitable for covering and contacting the sides of a yogurt culture container containing a yogurt culture. In one embodiment, the cover is both flexible and insulated. Suitable materials may include, for example, low density closed cell foamed neoprene, which provides both flexibility and thermal insulation for retaining heat. Other suitable materials may include, for example, fleece, quilted materials, electric blanket style materials, electric blanket style covers, durable bubble insulation, including bubble insulation, such as Reflectix®, or Insul Bright® which have a reflective coating. Many other suitable flexible and heat retaining materials are available and well known to those skilled in the art. Layers of protective or insulated materials may be used to form a flexible and/or robust cover for insulating a container. In one embodiment, heating elements and insulating material may be positioned between an inner and outer layer of rugged nylon, plastic, rubber, or other backing.

The flexible insulated cover may also be configured to cover and contact the sides of a yogurt culture container containing a yogurt culture. As the yogurt culture containers may be the same containers in which milk is purchased from the store, such as a gallon or half-gallon jug, the flexible insulated covers will either be sized precisely for standard container sizes, or will be adjustable. The flexible insulated covers can be made adjustable by, for example, utilizing stretchable material in all or a portion of the flexible insulated cover. Alternatively, the flexible insulated covers can be made to adjust or adapt to different container circumferences by using hook-and-loop fasteners on a portion of the cover, such that when the cover is wrapped around a yogurt culture container, such as a gallon jug of milk, the ends of the cover have hook-and-loop fasteners that allow the cover to be sized appropriately so that the cover contacts the sides of the yogurt culture container. In some embodiments, the flexible insulated cover is made of a first material suitable for enclosing a heating element, and a second material or fabric that has high elasticity and stretch, providing a wide range of acceptable sizing of the cover over the yogurt culture container. Thus, the cover may be insulating, flexible, and contain a heating element. The heating element may be flexible or rigid. For example, the heating element may be rigid with a shape to match at least a portion an exterior surface of a milk container.

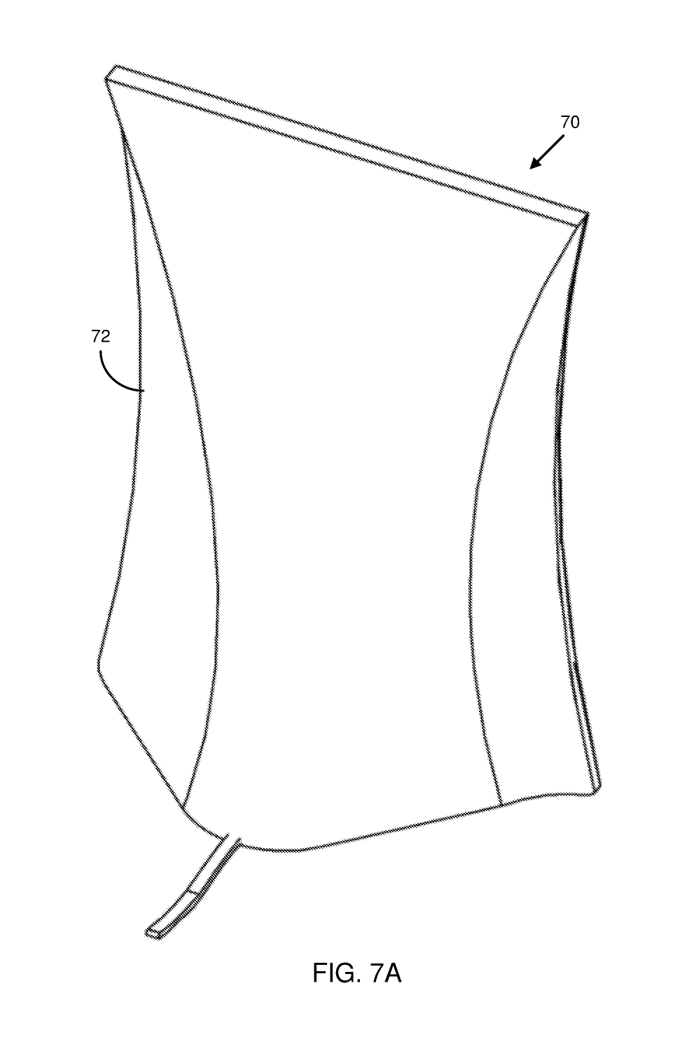

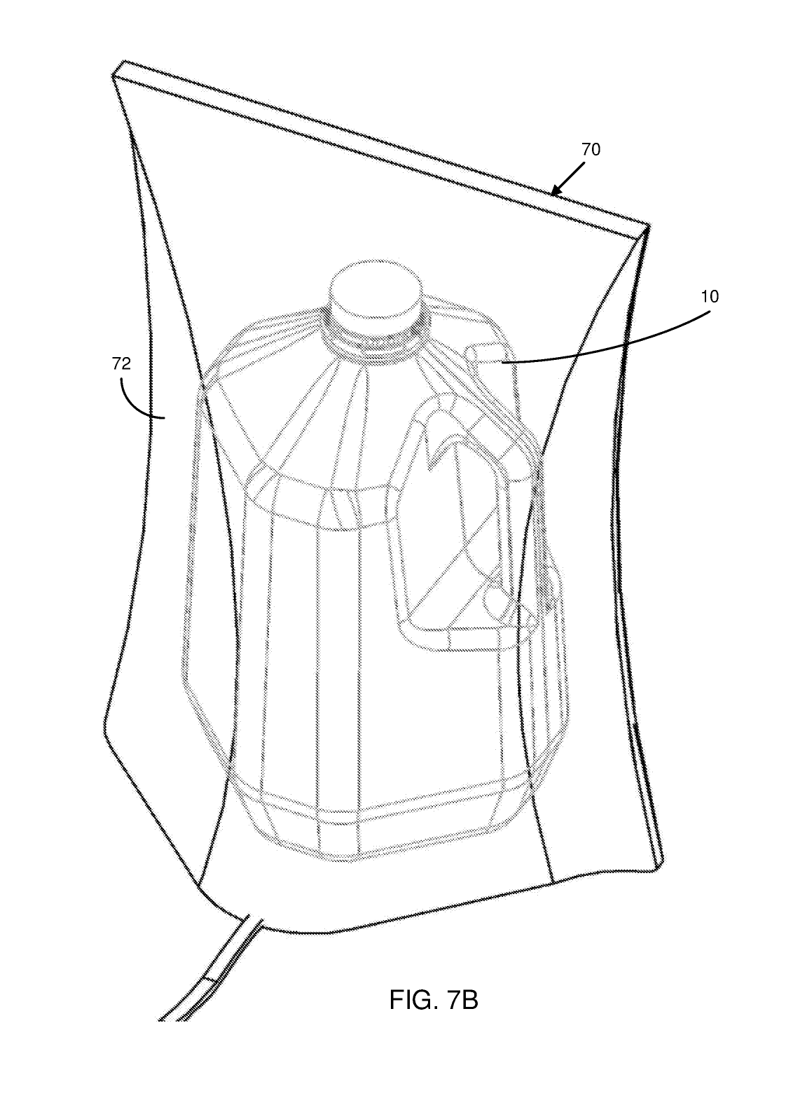

The flexible insulated cover may be manufactured from a single piece of material, in an envelope style of flexible insulated cover that can be made from a single rectangular shaped heating element that can be folded over to envelop the jug (See FIGS. 7A and 7B). Embodiments formed from a single piece may reduce manufacturing costs.

In other embodiments, the flexible insulated cover may be a cylindrical shape (or rectangle formed into a cylinder with a square or round top flap to cover top of cylinder). In one embodiment, the flexible insulated cover may have a mostly square cross-sectional shape tapers towards the top, similar to a cone or pyramid. A conical shape may be formed from a single piece that can be folded into a pyramidal shape or from four identical shapes that have been fastened or attached at the sides to form the pyramidal shape.

In another aspect, the embodiments of the present disclosure may further include a heating element dispersed within the flexible insulated cover. The heating elements include any type of element configured to generate heat, such as traditional heating elements, thermal wires, printed-on heating elements, foil heating elements, positive thermal coefficient of resistance (PTC) elements or mesh or printed, self-regulating wire, etc. The heating element itself may be flexible or rigid.

In another aspect, the present disclosure further includes a temperature regulator configured to regulate the heating element and maintain a temperature sufficient to culture and ferment the yogurt culture. The temperature regulator may include any suitable instrument capable of regulating and controlling heat, such as a thermostat, thermocouple, control circuit, self-regulating wire, positive temperature coefficient (PTC) elements that shut off heat automatically throughout the heating surface, etc. In one particular embodiment, the yogurt culture system of the present disclosure includes a thermostat to regulate the heating element and maintain a temperature sufficient to ferment the yogurt culture.

In some embodiments, the yogurt culture system may include a heating element that is dispersed within the entire flexible insulated cover. For example, the heating element may be located throughout the flexible insulated cover so that heat is distributed substantially evenly across an interior surface of the cover (or an exterior surface of a contained milk container). In other embodiments, the yogurt culture system of the present disclosure may include a heating element that is dispersed in only a portion of the flexible insulated cover. For example, in one particular embodiment, the heating element may be disposed in a first half of the flexible insulated cover, while the second half of the flexible insulated cover includes a highly stretchable and expandable material that enables the flexible insulated cover to contact the sides of a yogurt culture container containing a yogurt culture so as to transfer heat to the yogurt culture container more efficiently. Thus, in some embodiments, the yogurt culture system of the present disclosure may have at least a portion of the flexible insulated cover that includes a stretchable material that is configured to tighten the flexible insulated cover around the sides of the yogurt culture container.

In another aspect, at least one embodiment of the present disclosure includes a yogurt culture system in which the flexible insulated cover is closed at the top so as to cover the top of the yogurt culture container. This configuration may provide greater coverage by the cover over the yogurt culture container for purposes of heat retention and insulation, uniform heat distribution, energy efficiency, and/or the like.

In yet another aspect, improved heat retention and insulation may be achieved by providing an insulated bottom portion to which the flexible insulated cover is configured to connect to and form a closed flexible cover system. The insulated bottom portion further contributes to improved heat retention and insulation. The bottom portion may include a heating element and may be attached to vertical side walls or other portions of the flexible cover using a zipper, hook and loop fastener, or other fastener.

A yogurt culture system, may include a yogurt culture container, a flexible insulated cover covering and in contact with at least a portion of the side of the yogurt culture container, and a heating element dispersed within the flexible insulated cover.

In another aspect, the present disclosure provides a method for culturing yogurt. The method includes mixing a yogurt culture starter with milk in a container to produce a yogurt culture container containing a yogurt culture; covering the yogurt culture container with a flexible insulated cover configured to cover and contact the sides of a yogurt culture container, wherein the flexible insulated cover includes a heating element dispersed within the flexible insulated cover; contacting the sides of the yogurt culture container with the flexible insulated cover; and culturing the yogurt culture container under conditions sufficient to cause fermentation of the yogurt culture. For example, culturing the mix within the container may include heating the mix to a desired temperature and maintaining that temperature for a desired time period.

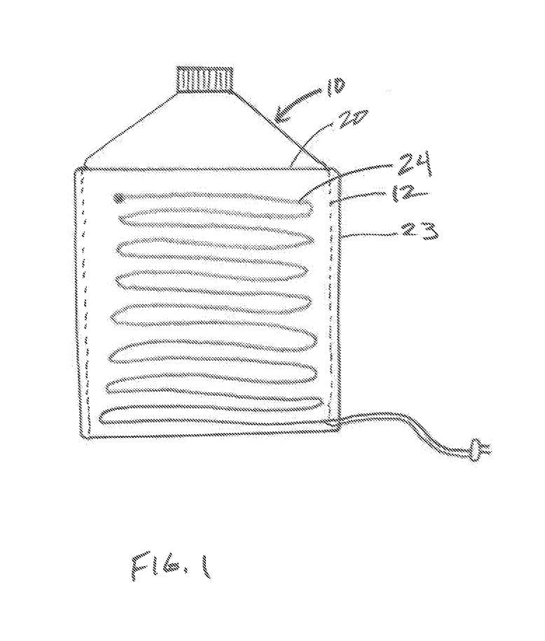

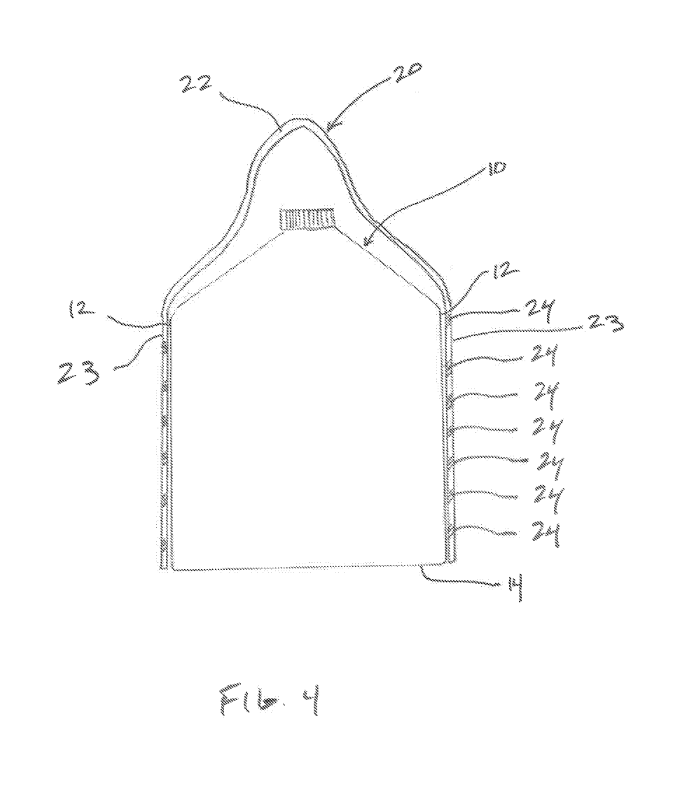

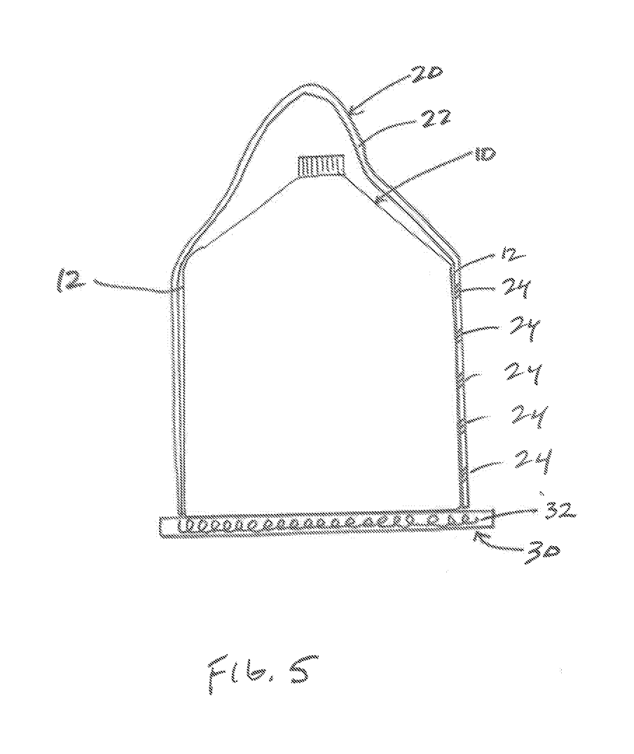

There are a number of possible implementations for the systems, devices, and methods disclosed herein, some of which are illustrated in the drawings. For example, one particular design is a drop over design. In a drop over design, the flexible over and/or heating elements may be dropped or pulled downward over the top of a milk container and are sized to cover and/or contact the walls of the milk container. For example, in the drop over design, as shown in FIGS. 4 and 5 of the drawings, the apparatus may be lowered over the top to provide heating and insulation (see also examples in FIGS. 1 to 3). As shown in FIG. 5, an insulated or heated bottom portion is placed underneath the yogurt culture container (e.g., milk jug) to connect to and form a closed flexible cover system. In other embodiments, the yogurt culture container can remain on the counter and the flexible insulated cover simply placed over the container.

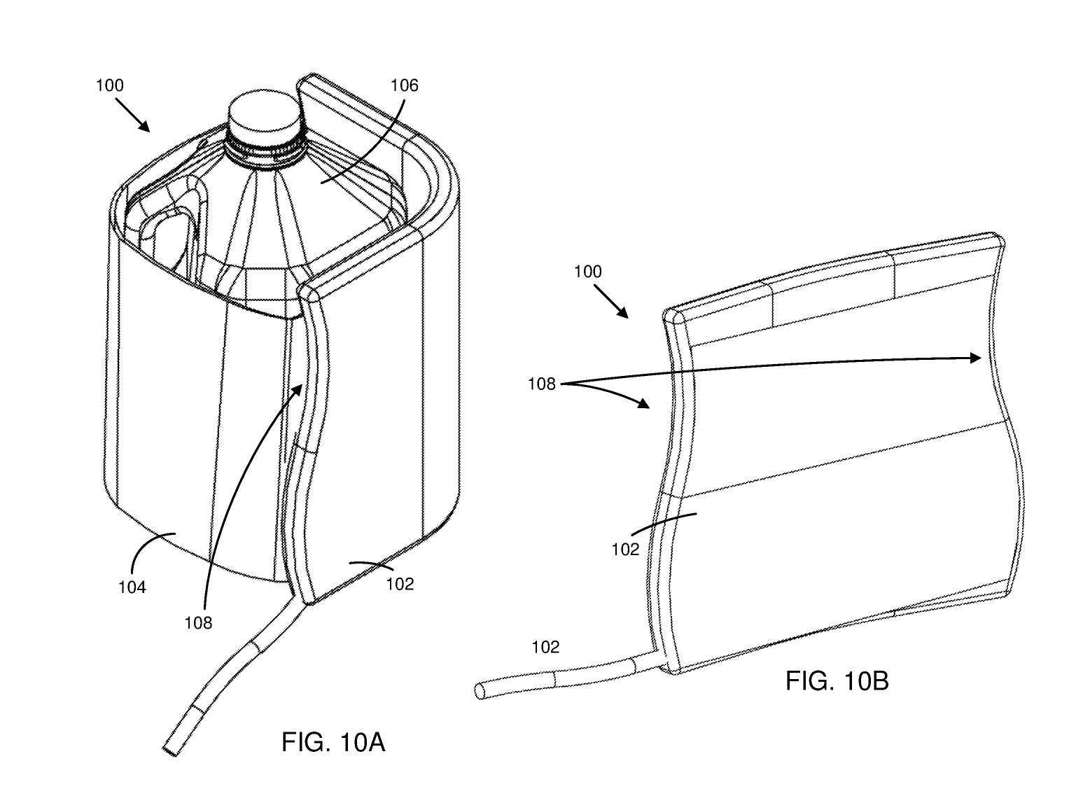

In alternative embodiments, the flexible insulated container may include silicone or flexible sides or top portions for easy storage. The configuration of the flexible insulated cover may include two rectangular shaped halves, with just one of the halves providing the heat with insulation and the other just insulation. The halves could also be trapezoidal in shape for ease of manufacturing so parts could be cut with no waste. For example, a first trapezoid may be cut from a sheet of material and a next trapezoid may be cut from the sheet in an inverted position. In one embodiment, an edge may have an hourglass shape with a more narrow top that can be cut from subsequent sections of a roll or sheet of material without waste (see FIGS. 10A and 10B). In some embodiments, the flexible insulated cover may be sewn or molded from a single piece, with a smaller heating element inserted into a pocket.

In some embodiments, the heating element within the flexible insulated cover may be supplemented with a heating element underneath the yogurt container, such as a hot plate, which uses a heating element from the bottom and then insulates the top and sides with a drop over cover, hard or soft clear plastic cover, elastic or hook-and-loop (Velcro) or snap or other wrap around cover.

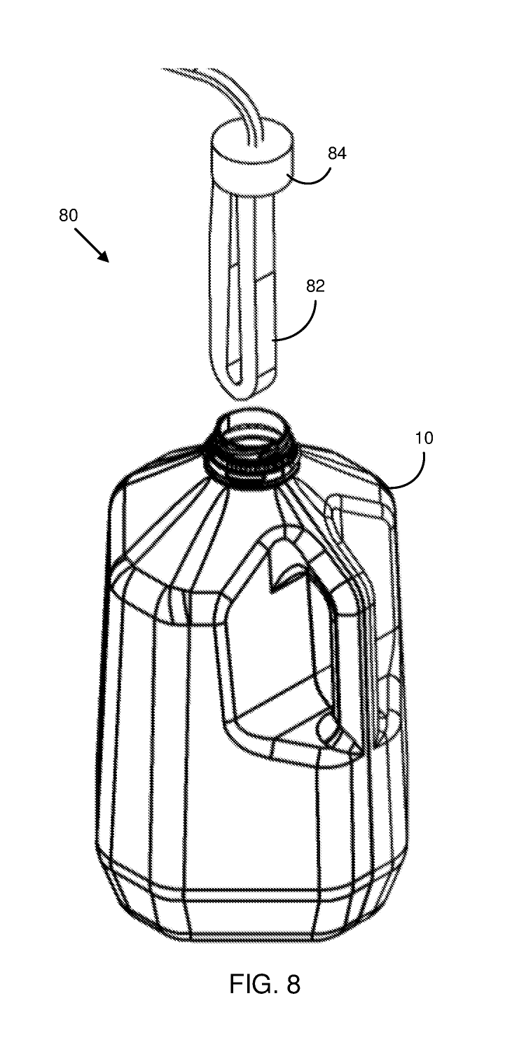

In other embodiments, a system may include an inserted heating element, in which an actual heating element is inserted down inside the milk and includes a cap or attaching portion that that attaches to standard milk jug opening using the threads at the container cap location (see FIG. 8). This may or may not be used in conjunction with a flexible insulated cover to provide more precise temperature control during culturing using the heating element.

In accordance with one embodiment, the heating elements is placed on a side of the yogurt culture container. For example, a heating element may be oriented vertically or be distributed vertically in a flexible cover to match a vertical side wall of a milk container. The heating elements disposed in the flexible insulated cover (e.g., between material or walls of the cover) may encompass a plurality of sides, or all sides of the yogurt culture container, for more even distribution of heat.

In some embodiments, the heating elements are disposed within the flexible insulated cover such that the flexible insulated cover can be folded or rolled up without damaging the heating elements. Desirably, the heating elements are made of a material that is sufficiently robust that folding or rolling of the flexible insulated cover will not damage the heating elements or interfere with the heating element functionality. In one embodiment, the heating elements are rigid so that the cover and heating elements may be stored by folding or by wrapping the cover around the rigid heating element(s).

In some embodiments of the present disclosure, the flexible insulated cover may further include a heat ring connected to the bottom edge of the flexible insulated cover to keep the cover draped over the yogurt culture container. For example, a lower edge or rim of the cover may include an elastic band or other material that causes the diameter or circumference of an opening to constrict or elastically shrink. In this embodiment, the flexible insulated cover may be dropped over the top of the milk jug, with the ring and/or collapsing blanket providing the heat and/or a thermostat to keep the jug at the correct temperature for culturing the yogurt.

Specific embodiments are illustrated in the drawings.

FIG. 1 shows a side view of yogurt culture container 10 that includes a standard sized gallon jug of milk (mixed with a suitable yogurt culture starter), around which container 10 is wrapped a flexible insulated cover 20. A flexible heating element 24 is disposed within the flexible insulated cover 20, such that the flexible insulated cover 20 wraps around at least a portion of the yogurt culture container and sides 23 of the cover contact at least a portion of the sides 12 of the yogurt culture container 10. The heating element 24 is disposed in only a single side of the flexible insulated cover 20 (e.g., the side facing the viewer), such that heat is transferred to the container from only a single side. The flexible cover 20 may wrap around the sides of the container 10 and help to retain heat within the container 10 or mixture in the container 10. The cover 20 has an opening at the top and bottom so that a portion of the container 10 extends above the cover 20 and a lower surface of the container 10 rests on a surface, such as a table or counter. Thus, the container 10 may be placed in the cover through the top or bottom opening, as desired by the user.

Culture starts may include starters for a wide variety of cultures or bacteria for a wide variety of base substances (e.g., such as animal milk, plant milk, or other base). Some example cultures include: Lactobacillus bulgaricus, Streptococcus thermophilus, Lactobacillus acidophilus, Bifidus regularis, Lactobacillus casei, Lactobacillus brevis, Lactobacillus casei subspecies casei, Lactobacillus casei subspecies Rhamnosus, Lactobacillus paracasei subspecies Paracasei, Lactobacillus fermentum, Lactobacillus cellobiosus, Lactobacillus delbrueckii subspecies Bulgaricus, Lactobacillus delbrueckii subspecies lactis, Lactobacillus fructivorans, Lactobacillus helveticus subspecies lactis, Lactobacillus hilgardii, Lactobacillus helveticus, Lactobacillus kefiri, Lactobacillus kefiranofaciens subspecies Kefirgranum, Lactobacillus kefiranofaciens subspecies Kefiranofaciens, Lactobacillus parakefiri, Lactobacillus plantarum, and the like.

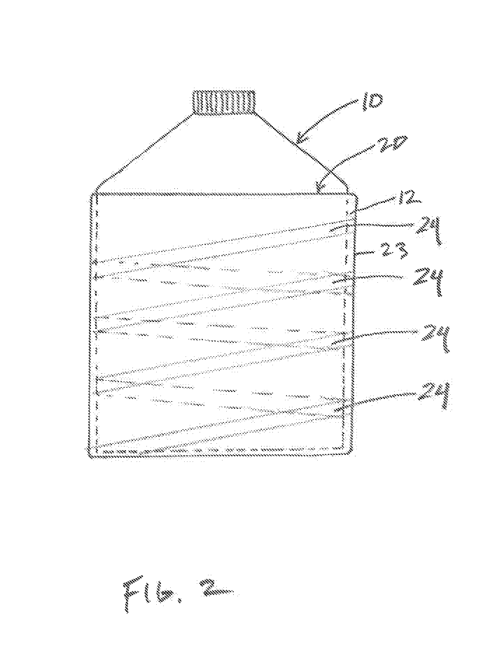

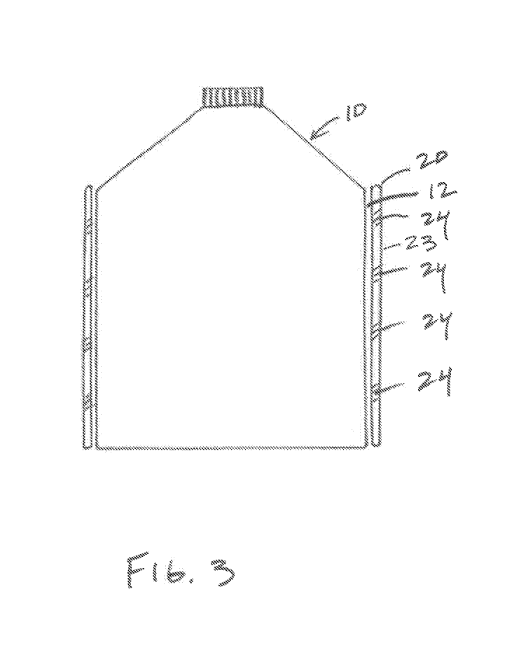

FIG. 2 shows a side view of an alternative embodiment, in which the heating elements 24 is disposed within the flexible insulated cover 20, such that the heating elements 24 wrap around the entire circumference of the yogurt culture container, so as to provide a more uniform distribution of heat transferred to the container. The heating elements 24 may include wire that is positioned in the cover 20 so that it forms a spiral around the container 10 so that at least a portion of the heating element is positioned to each side of the container 10. Furthermore, the heating element 24 is distributed throughout a height of the cover 20 so that a portion of the heating elements 24 are distributed throughout the full vertical height of a vertical sidewall of the container 10. FIG. 3 shows a sectional view of the container yogurt culture system shown in FIG. 2.

The heating elements 24 are shown within the cover 20. For example, the heating elements 24 may include heating wires that are positioned within the walls or exterior materials of the cover. For example, the heating elements may be positioned between an interior surface of the cover 20 and an exterior surface of the cover 20. Thus, the heating elements 24 may be contained within the cover to provide a functionally and visually simple cover 20. In one embodiment, the heating elements may be positioned or maintained in place by intervening insulation.

FIG. 4 shows an embodiment in which the flexible insulated cover 20 extends over and covers the top of the yogurt culture container 10, with a top portion 22 covering the top of the container and the sides. The cover 20 includes sidewalls to cover the sidewalls of a container 20, but also includes an enclosed upper end to trap heat within the container 20 and insulated cover. This may provide more uniform heating and/or reduced energy requirements to culture the mixture in the container 20. In the embodiment of FIG. 4, heating elements are positioned in the sidewalls but not within the top portion 22. In other embodiments, the heating elements may be positioned in the top portion 22 as well.

FIG. 5 shows an embodiment in which the flexible insulated cover 20 is further supplemented with a heated bottom portion 30 containing a separate heating element 32. The bottom portion 30 may or may not be flexible. The cover 20 plus bottom portion 30 may provide full coverage of the bottom, sides, and top of the container 10. In one embodiment a zipper, hook and loop fastener, or other fastener may be used to attach the bottom portion 30 to the cover 20. In one embodiment, the bottom portion 30 includes a heating element for applying heat to the mixture in the container. In one embodiment, there may be heating elements 24 in both the bottom portion and the cover 20. In one embodiment, only the bottom portion 30 may include a heating element while the cover 20 helps to retain heat in the mixture.

Embodiments herein may include any type of heat regulator, such as those discussed herein. In one embodiment, a self-regulating wire may act as both a heating element and a heat regulator. In some embodiments, a heat regulator may be included within a cover, bottom portion, or other portion of the system. Or the heat regulator may be located in a power cable, such as near a plug or near the cover 20.

In one embodiment, a heating element in the flexible cover may be positioned within an interior region formed by a cover. The cover may form an interior where a container is to be placed during culturing. For example, the heating element may not be located within the walls of a cover but may be positioned between the cover and a wall of the container, when the cover is positioned on the container.

In one embodiment, the heating element may be positioned in line or in series with the flexible cover. For example, the heating element may encompass a portion of the circumference of a sidewall of a container while the flexible cover, a strap, or the like encompasses a remaining circumference of the container. In some embodiments, it may not be necessary to completely enclose the container (e.g., from top to bottom), but a strap or flexible cover maybe used to hold the heating element against the side of the container.

In one embodiment, a flexible heated cover may be used to hold a heating element against a side, top, or bottom of a milk container. In one embodiment, the cover may help retain heat while the heating element helps to create heat. In one embodiment, a cover is not necessary and sufficient heat may be provided and/or retained using a heating element strapped, fixed, or otherwise held in contact with the container. For example, a belt may be used to strap a heating element to one or more sides of the milk container. As another example, a heating element may extend into the container through an opening. The heating element may be attached to and held in place relative to the jug using a threaded cap portion that can be attached to the opening in case of a cap that was originally provided with the milk container. In one embodiment, these heating elements strapped or affixed to a top or side of the container may be used with or without a cover. At least one system or apparatus may include a mount for securing a heating element to an exterior or interior of the container. For example, a threaded cap portion may secure a heating insert into an interior of a container. As another example, a belt or cover may secure a heating element to a side or top of the container. By securing a heating element to a container, it is possible to use the heating element for creating a yogurt culture in a wider range of shapes and sizes of containers. For example, many sizes of containers in which milk is generally sold may nevertheless have the same threaded cap portion or may be accommodated by a belt or cover portion using the principles and embodiments disclosed herein.

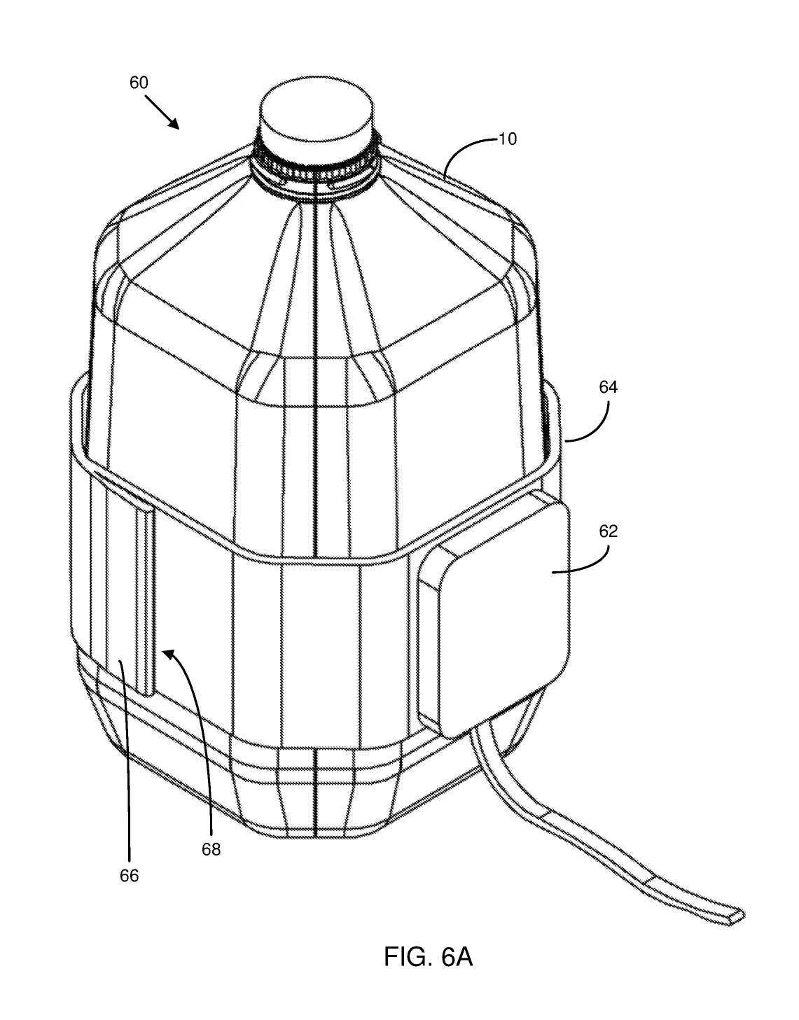

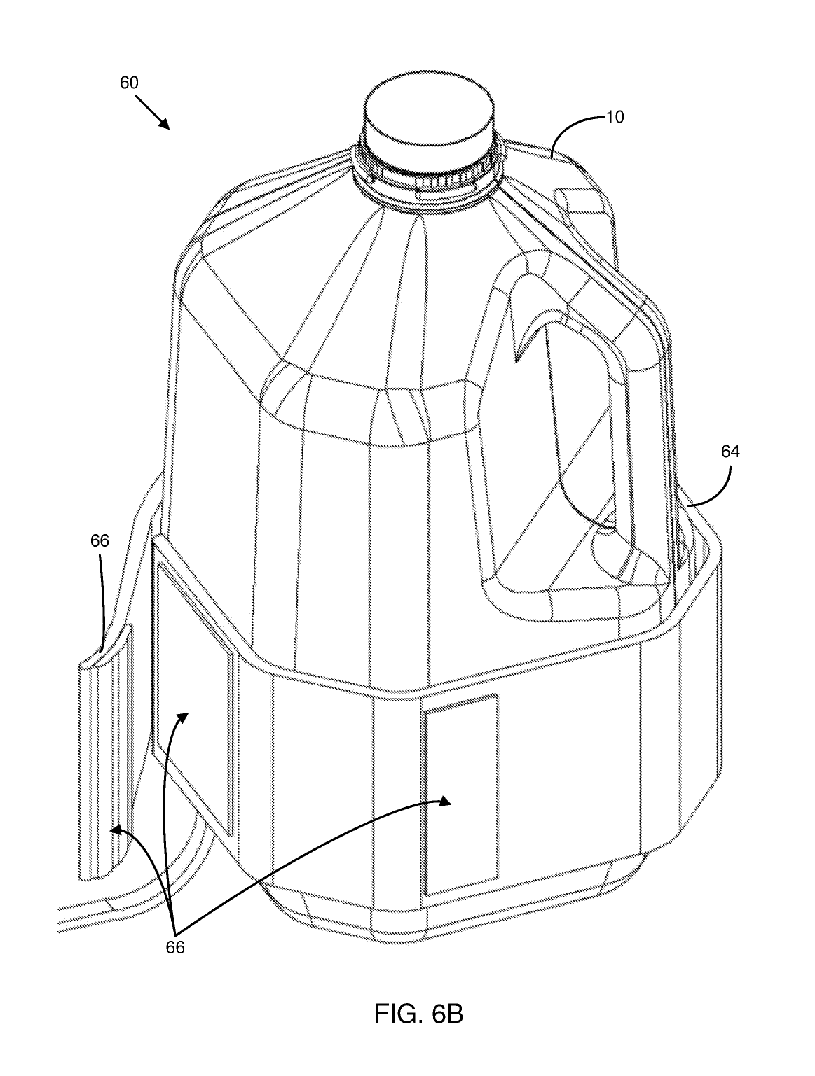

FIG. 6A is a perspective view of yogurt culture system 60 that includes a milk container 10 with a rigid heating element 62 strapped to the container using a belt 64. The belt 64 is formed of a flexible material that wraps around the container 10 to secure the heating element 62 in place. The belt 64 includes a first end 66 that attaches to a portion of the belt 64 using a fastener 68, such as a hook and loop fastener, or another fastener. In one embodiment, at least of the portion of the surface of the belt 64 is covered by a hook portion or loop portion to allow for attachment by a corresponding loop portion or hook portion on the first end 66 at a plurality of locations. This may allow the belt 64 to accommodate a wide range of different container circumferences, such as for gallon, half-gallon, or other sizes of containers. 6B illustrates the first end 66 pealed back to show hook and loop fastener portions 66. In one embodiment, the belt 64 may include an insulating material to provide some insulation during culturing. In one embodiment, the vertical height of the belt 64, as oriented, may be increased to provide greater coverage of the sidewalls or top of the container 10. For example, instead of a belt 64, one embodiment, may include a cover that that can be adjusted in length similar to the belt 64, to accommodate different container sizes. In one embodiment, the belt 64 or cover may include a heating element within the belt or cover.

In one embodiment, the belt 64 and heating element 62 may be used to heat a yogurt mixture in the container 10. A cover may also be placed over the container 10 to increase efficiency or improve uniformity. In one embodiment, no cover is needed because the heating element 62 provides sufficient heat to maintain the yogurt mixture at a proper temperature. In one embodiment, the belt 64 may include an insulating material to help retain at least a portion of the heat in the container 10.

FIG. 7A is a perspective view of a yogurt culture system 70 having an “envelope” style insulating cover 72. The insulating cover 72 may be formed by folding over one or more pieces of insulating material to form a pocket or envelope into which a container may be placed. Edges of the material may be sewn, adhered, welded (e.g., melted) together to form the pocket or cavity. FIG. 7B illustrates a milk container 10 within the envelope. The cover 702 may include heating elements dispersed throughout or in a portion of the walls to provide heating to the container 10. The material of the cover 70 may be flexible, elastic, and insulating. Additionally, a heating element may be within the pocket or cavity formed by the cover 72. In one embodiment, the heating element may be positioned within the material (e.g., between the walls or materials of the insulating material of the cover 70).

FIG. 8 illustrates a yogurt culture system 80 that uses a heating insert 802 that includes a probe. The heating insert 82 includes a probe that generates heat and extends downward into the container 10 through the opening of the container 10. The heating element 82 may have a length extending more than halfway, more than ¾ of the way, or up to the full height/depth of the interior of the container 10. The heating insert 82 includes a cap portion 84 that has threading corresponding to a threaded opening of the container 10 or jug. The heating inert 802 may be used with or without an insulating cover. For example, an insulating cover may be placed over the top of the container 10 and heating insert 82 after the heating insert has been placed in the container 10.

Various other embodiments that can be used to attach a heating element on or in a standardized milk container are also contemplated. For example, the size of a heating insert 82 may vary based on the types of containers that might be used to culture yogurt. In one embodiment, any system for attaching heating elements to a side, top, or to an interior of a retail milk container may be used without departing from the scope and teaching of the present disclosure.

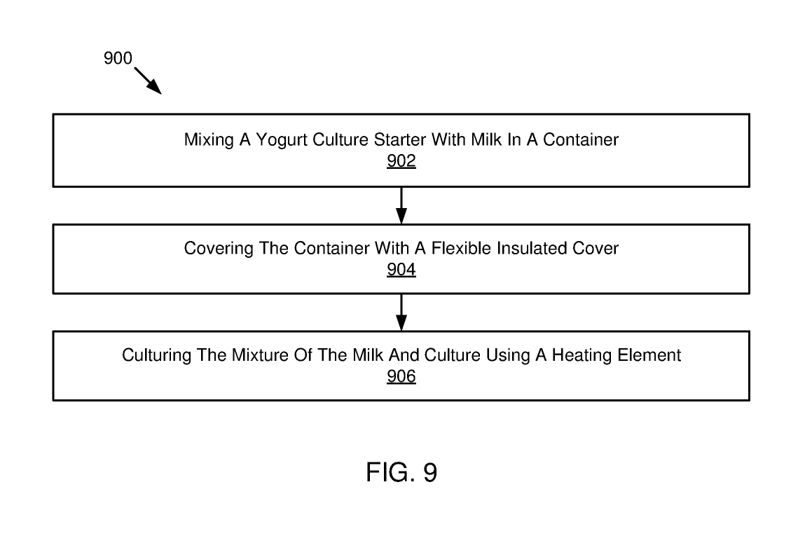

FIG. 9 is a schematic flow chart diagram illustrating a method 900 for creating yogurt or culturing a yogurt mixture. The method 900 begins and a yogurt culture is mixed 902 with milk in a container. The milk may include cow's milk, soy milk, goat milk, almond milk, or any other type of milk. Example containers may be one quart, a half-gallon, one gallon, one liter, two liter, or other common retail sized foodstuff container. The yogurt culture may include a yogurt culture started and may be mixed 902 into a container in which the milk was purchased, such as a milk jug. The milk container is covered 904 using a flexible insulated cover. In one embodiment, instead of using a flexible insulated cover, a heating element is attached to the container. The cover and/or heating element may contact the sides of the container. The flexibility of the cover may allow the cover to accommodate the circumference or shape of the container. The cover may also be elastic to allow it to stretch and constrict to maintain contact with substantially all of the vertical sidewalls of a container. In one embodiment, the heating element is dispersed within the flexible insulated cover. The mixture is cultured 906 under conditions sufficient to cause fermentation of the yogurt culture. For example, the mixture may be cultured by plugging in a power cord, pressing a button, or otherwise initiating a heating process to culture the mixture. In one embodiment, a heating element provides heat to the mixture to allow the cultures to culture the mixture.

FIGS. 10A and 10B illustrate one embodiment of a cover 100 having edges 108 with an hourglass profile. The cover 100 includes a heated portion 102 and an elastic portion 104. FIG. 10A shows the cover 100 wrapped around a container 106. FIG. 10B shows the cover 100 in a collapsed configuration. The heated portion 102 may include one or more heating elements between insulating or cover materials. In one embodiment, the heating elements are near an interior surface of the cover 100 with insulating material neat an outside surface to trap and provide heat to a container 106. The elastic portion 104 may include a stretchable portion that can stretch to accommodate a plurality of container sizes.

The edges 108 of the heated portion 102 have a curved hourglass shape which allows a series of cover shapes to be cut from one or more sheets of material (e.g., each alternating shape may be inverted or upside down). The hourglass shape (with a wider base and a more narrow top allow the cover 100 to adapt to containers which are often more narrow at the top than at the bottom. The hourglass shape may also provide a pleasing appearance. In the flat configuration, the cover 100 is very compact and can be stored in a drawer or with cookie sheets or other flat items.

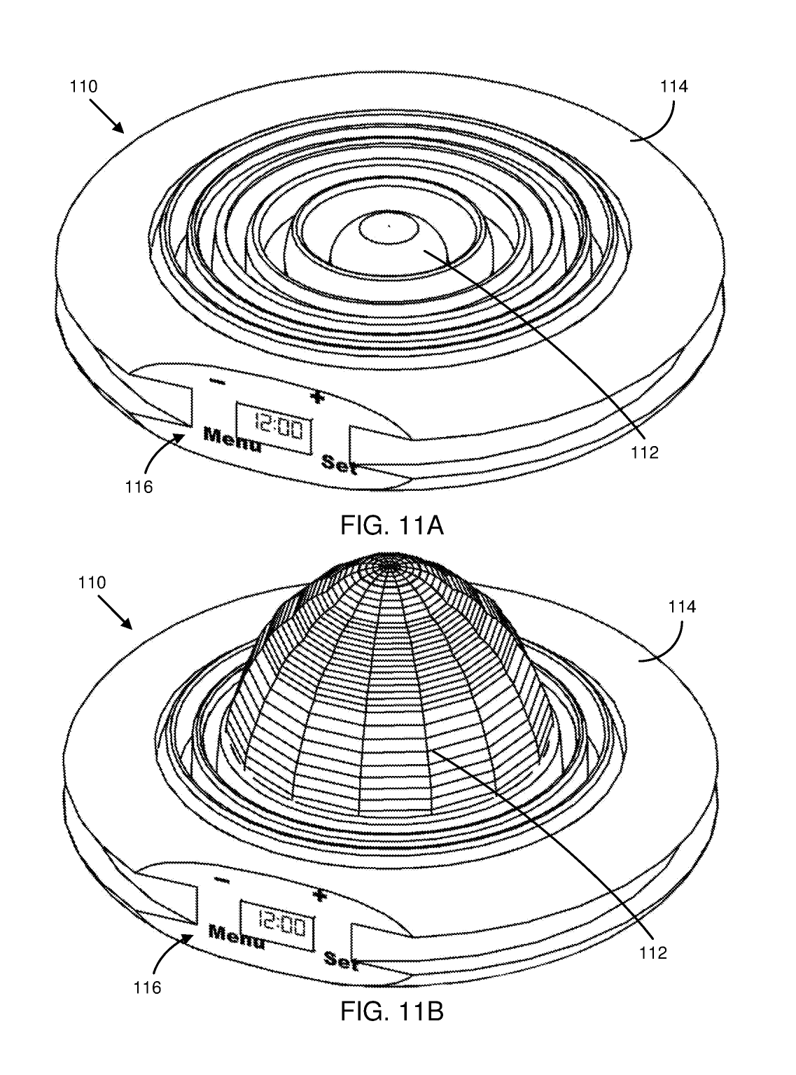

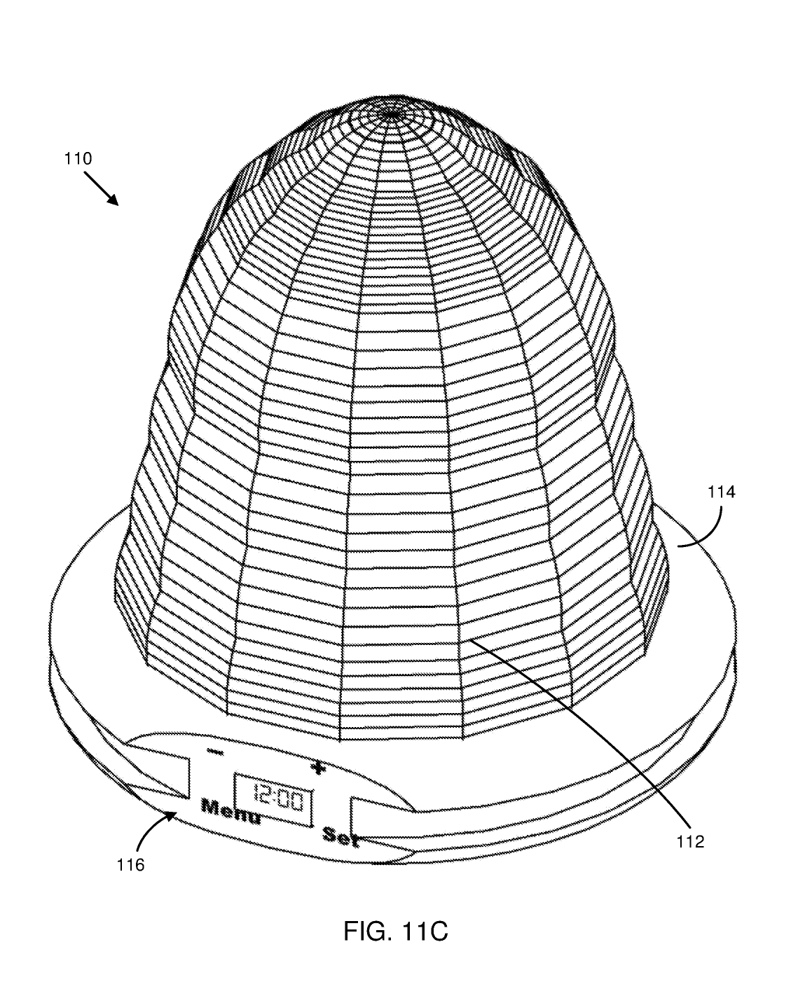

FIGS. 11A, 11B, and 11C illustrate one embodiment of a yogurt culture system 110 that includes a flexible cover 112 mounted in a base ring 114. The flexible cover 112 may be folded up into a flat configuration, as shown in FIG. 11A, or expanded into an open configuration, as shown in FIG. 11C. FIG. 11B shows the cover 112 in a partially expanded configuration. The flexible cover 112 may include a foldable and flexible silicon, fabric, or other material cover with embedded heating elements. The flexible cover 112 may include a plurality of folds which can be selectively collapsed or extended between different positions or configurations. The heating elements may receive power via the base ring 114. The base ring 114 also includes an interface 116 for controlling operation of the system 110.

Due to the expandable/flexible nature of the flexible cover 112, the system 110 may adapt to a wide range of container sizes and types. For example, the system 110 may be dropped over the top of a container and expand until the base ring 114 rests on a surface. The height and width of the container may cause the flexible cover to only partially or fully expand. For example, a gallon jug may cause the cover 112 to expand as is illustrated in FIG. 11C while a pint or quart container may cause the cover 112 to expand as illustrated in FIG. 11B. Once in place, a culturing process may begin by selecting an option on the interface 110. Control electronics within the base 110 may control the amount of power provided to the heating elements within the flexible cover 112 to provide a desired heating curve to allow for control of the culturing in a variety of ways. A power cord may provide power to the base 110.

Example embodiments and accompanying drawings are discussed in reference to the numerals provided therein so as to enable one skilled in the art to practice the principles and disclosed embodiments. The skilled artisan will understand, however, that the apparatuses, systems and methods described herein can be practiced without employing these specific details, or that they can be used for purposes other than those described herein. Indeed, they can be modified and can be used in conjunction with products and techniques known to those of skill in the art in light of the present disclosure. The drawings and descriptions are intended to be examples of various aspects of the disclosure and are not intended to narrow the scope of the appended claims. Furthermore, it will be appreciated that the drawings may show aspects in isolation and the elements in one figure may be used in conjunction with elements shown in other figures.

Reference in the specification to “one configuration” “one embodiment,” “a configuration” or “an embodiment” means that a particular feature, structure, or characteristic described in connection with the configuration is included in at least one configuration, but is not a requirement that such feature, structure or characteristic be present in any particular configuration unless expressly set forth in the claims as being present. The appearances of the phrase “in one configuration” in various places may not necessarily limit the inclusion of a particular element of the disclosure to a single configuration, rather the element may be included in other or all configurations discussed herein.

Furthermore, the described features, structures, or characteristics of configurations of the disclosure may be combined in any suitable manner in one or more configurations. In the description, numerous specific details are provided, such as examples of products or manufacturing techniques that may be used, to provide a thorough understanding of configurations of the disclosure. One skilled in the relevant art will recognize, however, that configurations of the disclosure may be practiced without one or more of the specific details, or with other methods, components, materials, and so forth. In other instances, well-known structures, materials, or operations are not shown or described in detail to avoid obscuring aspects of the disclosure.

It should be understood that the present disclosure is not limited to any particular structures, process steps, or materials discussed or disclosed herein, but is extended to include equivalents thereof as would be recognized by those of ordinarily skill in the relevant art. More specifically, the disclosure is defined by the terms set forth in the claims appended hereto, any future claims submitted here and in different applications, and their equivalents. It should also be understood that terminology contained herein is used for the purpose of describing particular aspects of the disclosure only and is not intended to limit the disclosure to the aspects or configurations shown unless expressly indicated as such. Likewise, the discussion of any particular aspect of the disclosure is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “a heating element” may include one or more of such heating elements, and reference to “the backing” may include reference to one or more of such layers.

As used herein, the term “substantially” refers to the complete or nearly complete extent or degree of an action, characteristic, property, state, structure, item, or result to function as indicated. For example, an object, such as tubing, that is “substantially” enclosed would mean that the object is either completely enclosed or nearly completely enclosed. The exact allowable degree of deviation from absolute completeness may in some cases depend on the specific context, such that enclosing nearly all of the length of a piece of tubing would be substantially enclosed, even if the distal end of the structure enclosing the tubing had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

While the embodiments of the disclosure have been described in particular with reference to certain illustrated configurations, such is not intended to limit the scope of the disclosure. The disclosure encompasses other specific forms without departing from its spirit or essential characteristics. The described configurations are to be considered as illustrative and not restrictive. The scope of the disclosure is to be defined by the claims appended hereto, any future claims submitted here and in different applications, and their equivalents. All changes which come within the meaning and range of equivalency of the claims are to be embraced within their scope.

1. A yogurt culture system, comprising:
a flexible insulated cover configured to cover and contact the sides of a yogurt culture container containing a yogurt culture;
a heating element dispersed within the flexible insulated cover; and
a temperature regulator configured to regulate the heating element and maintain a temperature sufficient to ferment the yogurt culture.

2. The yogurt culture system of claim 1, wherein the heating element is dispersed within the entire flexible insulated cover.

3. The yogurt culture system of claim 1, wherein at least a portion of the flexible insulated cover comprises a stretchable material.

4. The yogurt culture system of claim 1, wherein the flexible insulated cover is closed at the top so as to cover the top of the yogurt culture container.

5. The yogurt culture system of claim 4, further comprising an insulated bottom portion to which the flexible insulated cover is configured to connect and form a closed flexible cover system.

6. The yogurt culture system of claim 1, further comprising a thermostat to regulate the heating element and maintain a temperature sufficient to ferment the yogurt culture.

7. A yogurt culture system, comprising
a yogurt culture container;
a flexible insulated cover covering and in contact with at least a portion of the side of the yogurt culture container; and
a heating element dispersed within the flexible insulated cover.

8. The yogurt culture system of claim 7, wherein the heating element is dispersed within the entire flexible insulated cover.

9. The yogurt culture system of claim 7, wherein at least a portion of the flexible insulated cover comprises a stretchable material.

10. The yogurt culture system of claim 7, wherein the flexible insulated cover is closed at the top so as to cover the top of the yogurt culture container.

11. The yogurt culture system of claim 10, further comprising an insulated bottom portion to which the flexible insulated cover is configured to connect and form a closed flexible cover system.

12. The yogurt culture system of claim 7, further comprising a thermostat to regulate the heating element and maintain a temperature sufficient to ferment the yogurt culture.

13. A method for culturing yogurt, comprising:
mixing a yogurt culture starter with milk in a container to produce a yogurt culture container containing a yogurt culture;
covering the yogurt culture container with a flexible insulated cover configured to cover and contact the sides of a yogurt culture container, wherein the flexible insulated cover comprises a heating element dispersed within the flexible insulated cover;
contacting the sides of the yogurt culture container with the flexible insulated cover; and
culturing the yogurt culture container under conditions sufficient to cause fermentation of the yogurt culture.

14. The method of claim 13, wherein the heating element is dispersed within the entire flexible insulated cover.

15. The method of claim 14, wherein at least a portion of the flexible insulated cover comprises a stretchable material.

16. The method of claim 14, wherein the flexible insulated cover is closed at the top so as to cover the top of the yogurt culture container.

17. The method of claim 13, further comprising an insulated bottom portion to which the flexible insulated cover is configured to connect and form a closed flexible cover system.

18. The method of claim 13, further comprising a thermostat to regulate the heating element and maintain a temperature sufficient to ferment the yogurt culture.

19. A yogurt culture apparatus, comprising:
a heating element for heating a yogurt culture within a container;
a mount configured to mount the heating element on or within the container; and
a temperature regulator configured to regulate the heating element and maintain a temperature sufficient to ferment the yogurt culture.

20. The yogurt culture apparatus of claim 19, wherein the mount comprises one or more of:
a threaded cap portion to secure the heating element within an interior of the container;
a belt for securing the heating element to a side of the container; or
a flexible cover for securing a heating element to one or more sides of the container.
